(19) United States
(12) Patent Application Publication
(10) Pub. No.: US 2026/0079806 A1
(43) Pub. Date: Mar. 19, 2026

(54) SYSTEM AND METHOD FOR GENERATING REPORT

(71) Applicant: Honeywell International Inc., Charlotte, NC (US)

(72) Inventors: Ankit Singh, Apex, NC (US); Timothy Sneed, Beachwood, NJ (US); Arun Ramasubrahmanyan, Burlington, NJ (US); Waad Subber, Schenectady, NY (US); Abhishek Hiremath, Scarborough (CA)

(21) Appl. No.: 18/887,037

(22) Filed: Sep. 17, 2024

(51) Int. Cl. G06F 11/30; G06F 40/186; G06F 40/205

(52) U.S. Cl. CPC G06F 11/3072; G06F 40/186; G06F 40/205

(57) ABSTRACT

The present disclosure relates to a method for generating reports for a product or process. The method comprises receiving a first user input defining a user role and user requirement for generation of a report of a commercial process or product. The method further comprises identifying one or more data sources storing information related to the commercial process or product, wherein the information includes raw data related to the commercial process or product, processed output obtained by performing statistical computations on the raw data, and reports including the processed output. The method also comprises retrieving the information related to the commercial process or product from the one or more data sources, determining associations of previously performed statistical computations with the first user input and the information related to the commercial process or product. The method further comprises providing one or more recommendations based on the associations, receiving a second user input related to one or more selections made from the one or more recommendation, and generating the report based on the second user input. A system and non-transitory computer-readable storage medium for generating reports are also disclosed.

### TECHNICAL FIELD

The present disclosure relates to a computer implemented method for document generation, and particularly, relates to data processing for report generation.

### BACKGROUND

Several reports are generated by enterprises for documenting information related to a commercial product or process. The information documented in such reports are generally indicative of the quality of a commercial product or process, and such quality reports can be used for deciding future actions or strategies with respect to such product or process. Generally, such quality reports contain information relating to quality management issues, recommendations for corrective action(s) to be taken, and a summary of findings of testing and control activities performed for the product or process. The quality reports may also include statistics such as success rate, failure rate, trend analysis, capability analysis, product recall rate etc., which may be used to judge the quality of the commercial product or process.

For instance, a quality report can be generated for a pharmaceutical product developed by a company. The quality report may record essential information related to the pharmaceutical product, such as details relating to formula and specifications, statistical data relating to batches manufactured, data on raw and packaging materials, data on complaints, returns and recalls relating to the product, supplier qualification, data regarding critical attributes of the product and critical process parameters of the manufacturing process of the product, results of stability studies etc. The report may also record a batch failure rate of the pharmaceutical product, the trends analysis with respect to market performance of the product etc.

The quality reports for a commercial product or process may be a compilation of multiple reports or chapters, wherein each of the multiple reports may be associated with an aspect of the commercial product or process. In the context of the example of a quality report generated for a pharmaceutical product, the quality report may be a compilation of a plurality of different reports, where each report relates to some feature or aspect of the pharmaceutical product. For instance, the reports may relate to, or be associated with, a stage of production of the product, composition of the product, acquisition of ingredients, conditions maintained for the manufacturing of the product, quality testing of the product, and similar products having different ratios of the composition used for the product. Each report may contain information obtained based on statistical computations performed on data relating to the product.

The compilation of reports to obtain a quality report is generally a complex and difficult process, as the reports are generated by different entities or individuals using different types of information and different formats of information. Further, the configuration of the chapters or reports constituting a quality report to be generated may not be clearly defined by many enterprises or factories, and the compilation of such reports becomes difficult. Further still, the individuals designated for the generation of reports in such enterprises may not be able to make informed choices regarding the statistical computations to be used and data to be generated for the reports.

In addition to such difficulties in generating a quality report, statistical computations performed corresponding to each report creates significant computational load on hardware features of systems used in enterprises for generating such reports. For example, insightful statistical data or information relating to a product or process, or an aspect of the product or process included in quality reports are obtained after performing a plurality of statistical computations on data relating the product or process. The statistical computations used for generating such information may be simple mathematical computations such a standard deviation, median, mean etc., or may be complex computations involving multiple steps and calculations which increases the computational load on hardware features of systems.

In most industries, statistical computations are performed afresh for each report generated. In instances where the same or similar reports are generated frequently, performing statistical computations afresh are repetitious, and need to be performed afresh each time. Such repeated performance of statistical computations may occur in instances such as where same or similar reports are generated frequently, when reports are to be generated for different variants of product, or when a same report are generated for different batches of a product. In such cases there is a redundancy in the efforts of users generating such reports and inefficient utilization of the processing hardware for performing the same computations in a repeated manner. For example, a pharmaceutical company may create different variants of a pharmaceutical product, and multiple batches may be manufactured by the pharmaceutical company corresponding to each variant. The pharmaceutical company may be required to generate reports for each batch of each variant of the pharmaceutical product. The statistical computations used in such reports may be the same or substantially similar as they are used for variants of the same product, and hence performing the statistical computations repeatedly would lead to inefficient use and excessive computations load on processing hardware used for generating such reports. Thus, existing methods for generating reports of same or similar statistical computations results in inefficient utilization of time and effort of users, along with excessive computation load on processing hardware.

Hence, there is a need of an efficient method of generating reports that overcomes the above described limitations.

### SUMMARY OF THE INVENTION

In general, embodiments of the present disclosure herein provide a system and method for generating reports. Other implementations will be, or will become, apparent to one with skill in the art upon examination of the following figures and detailed description. It is intended that all such additional implementations be included within this description be within the scope of the disclosure and be protected within the scope of the following claims.

In accordance with an embodiment of the present disclosure, a method of generating reports is described. The method comprises receiving a first user input defining a user role and user requirement for generation of a report of a commercial process or product. The method further comprises identifying one or more data sources storing information related to the commercial process or product, wherein the information includes raw data related to the commercial process or product, processed output obtained by performing statistical computations on the raw data, and reports including the processed output. The method also comprises retrieving the information related to the commercial process or product from the one or more data sources, determining associations of previously performed statistical computations with the first user input and the information related to the commercial process or product. The method further comprises providing one or more recommendations based on the associations, receiving a second user input related to one or more selections made from the one or more recommendation, and generating the report based on the second user input.

In one aspect, a Machine Learning (ML) model is used for identifying the associations and generating the report.

In another aspect, the user requirement is received as a user response to system prompts, and the user response is provided as a selection of predefined options or as a natural language response. Further, the natural language response is parsed by a Natural Language Processing (NLP) parser for determining a context of the user requirement for enabling identification of the associations. The associations are continuously updated based on one or more of the first user input and the second user input, provided for generating the report.

In another aspect of the embodiment, the method also includes determining associations of previously used report layouts with the first user input and information related to the commercial product or process.

In another aspect of the embodiment, each recommendation corresponds to a statistical computation or a report layout obtained from the associations. Each recommendation is provided as an editable template from a set of existing templates. Further, new templates are generated based on modifications made by the user to one or more of the templates.

In another aspect, the statistical computations are performed on the information for inclusion of one or more of trend analysis, defect analysis, success or failure analysis, and compliance analysis in the report.

In another aspect, the information for generation of the report is accessed from a plurality of data sources, and the information present in multiple formats is converted into a single format, before identification of the associations.

In another embodiment of the present invention, an exemplary system for generating reports is provided. The system comprises a processor and a memory coupled with the processor, wherein the memory stores program instructions configured to receive a first user input defining a user role and user requirement for generation of a report of a commercial process or product. Further, the program instructions are also configured identify one or more data sources storing information related to the commercial process or product, wherein the information includes raw data related to the commercial process or product, processed output obtained by performing statistical computations on the raw data, and reports including the processed output. The program instructions are also configured to retrieve the information related to the commercial process or product from the one or more data sources, and determine associations of previously performed statistical computations with the first user input and the information related to the commercial process or product. Further still, the program instructions are configured to provide one or more recommendations based on the associations, receive a second user input related to one or more selections made from the one or more recommendation, and generate the report based on the second user input.

In yet another embodiment of the present invention, a non-transitory computer-readable storage medium is provided comprising computer program code for execution by one or more processors of an apparatus, the computer program code configured to, when executed by the one or more processors, cause the apparatus to receive a first user input defining a user role and user requirement for generation of a report of a commercial process or product. The computer program code is also configured to identify one or more data sources storing information related to the commercial process or product, wherein the information includes raw data related to the commercial process or product, processed output obtained by performing statistical computations on the raw data, and reports including the processed output. Further, the computer program code is also configured to retrieve the information related to the commercial process or product from the one or more data sources, and determine associations of previously performed statistical computations with the first user input and the information related to the commercial process or product. Further still, the computer program code is also configured to provide one or more recommendations based on the associations, receive a second user input related to one or more selections made from the one or more recommendation, and generate the report based on the second user input

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates the hierarchy in enterprises for generating reports, in accordance with an embodiment of the present invention;

FIG. 2 illustrates a proposed system for generating reports, in accordance with an embodiment of the present invention;

FIG. 3 illustrate a block diagram of a proposed system for generating reports, in accordance with an embodiment of the present invention;

FIG. 4 illustrates steps executed by a system for generating reports, in accordance with an embodiment of the present invention;

FIG. 5 illustrates a system for retrieving information for report generation, in accordance with an embodiment of the present invention;

FIG. 6 illustrates a system for identifying associations of a user input and a product or process with previously performed statistical computations for report generation, in accordance with an embodiment of the present invention;

FIG. 7 illustrates a system for providing recommendations for report generation, in accordance with an embodiment of the present invention;

FIG. 8 illustrates a system for generating reports based on selection of recommendations, in accordance with an embodiment of the present invention; and

FIG. 9 illustrates a flow chart of a method of report generation, in accordance with an embodiment of the present invention.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way that enables one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labelled with the same reference numerals. However, sometimes these elements may be labelled with differing numerals, such as, for example, in cases where such labelling facilitates a clearer description. Additionally, the drawings set forth herein are not necessarily drawn to scale, and in some instances, proportions may have been exaggerated to more clearly depict certain features. Such labelling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

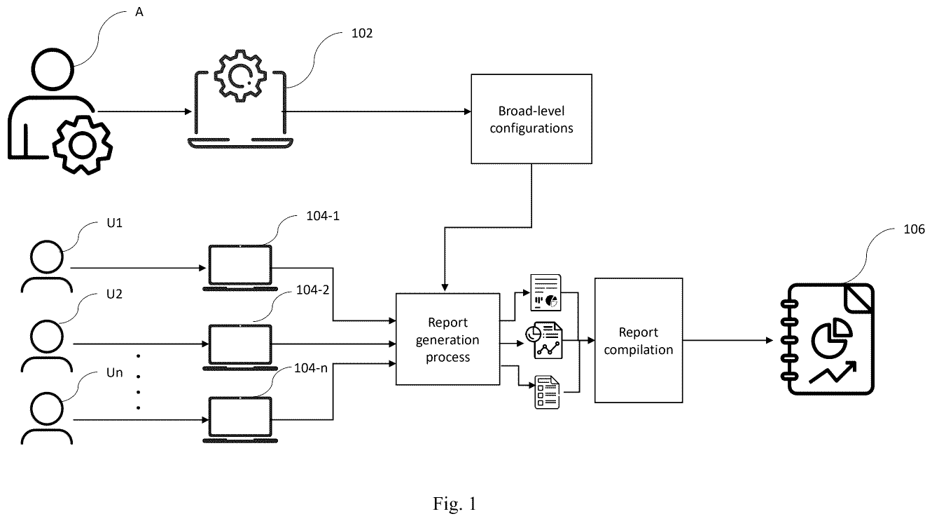

In many enterprises, reports are generated by a plurality of users. In such enterprises, a user may be an individual within an enterprise entrusted to generate a report for an aspect or feature of a product or process, or for the product or process as a whole. FIG. 1 illustrates the hierarchy in enterprises for generating reports, in accordance with an embodiment of the present invention. In such enterprises, there may exist an administrative user A who is designated with performing broad level configurations corresponding to generation of a final report for a process or product. The administrative user A performs such broad level configurations by means of a device 102. The broad-level configurations performed by the administrative user A include dividing the final report into multiple reports, wherein the multiple reports correspond to different aspects or features of the product or process. The broad-level configurations performed by the administrative user A also includes allocating each of the multiple reports to one or more other users U1 to Un (collectively referred to as U) within the enterprise, wherein the allocation is done based on role of the users U. Based on the allocation, the administrative user A may also determine or specify statistical computations to be performed with respect to each report. For example, the reports relating to performance of a product with respect to a series of quality tests is allocated to a user whose role is that of quality testing. The broad-level configuration performed by the administrative user A may also include assigning different duties or responsibilities to each user role with respect to report generation.

Based on the broad-level configurations made by the administrative user A, multiple reports are generated by one or more of the other users U, wherein each report is generated by a designated user U1 to Un. The users U may provide one or more inputs corresponding to reports to be generated using devices 104-1 to 104-n (collectively referred to as 104). The one or more inputs provided by each user are narrow-level configurations corresponding to the associated report, where the configurations would define the contents of the report and layout of the report. Such configurations may enable relevant customizations to be made based on the data and knowledge associated with the one or more users. Reports generated by the users U1 to Un are compiled to form the final report 106.

Hence, for such enterprises where reports are to be generated by different users U1 to Un within the enterprise, there may be multiple statistical computations that are performed afresh during each report generation. Such practices lead to redundancy of actions performed by different user, wastage of efforts of the users, and an increase in load faced by hardware features of a system or device used for generating the reports. Further, identification of statistical computations to be performed may be difficult for many users. The present disclosure relates to a method and system for generating reports that overcomes such difficulties by minimizing computational load and user efforts.

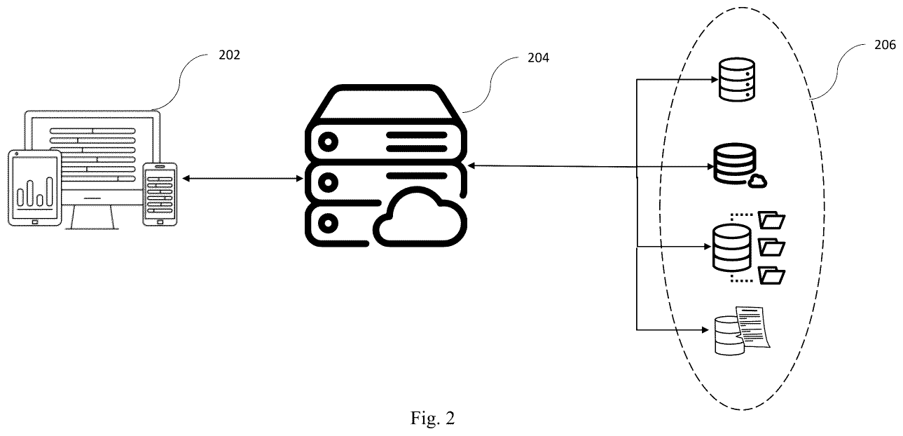

FIG. 2 illustrates a proposed system for generating reports in accordance with an embodiment of the present invention. The system 204 can be used by different users within an enterprise, where each user is designated to generate a report based on board-level configurations provided by an administrative user A. The report each user is designated to generate relates to a product or process, or an aspect of a product or process, developed or manufactured by the enterprise. The system 204 is connected with a user device 202 for retrieving a plurality of user inputs from users of the enterprise. In one implementation, the user device 202 retrieves a plurality of user inputs from a user U1 of the enterprise, hereafter referred to as “the user”. The user device 202 may be a computer, a laptop, a tablet, a smartphone or any other device used for retrieving user inputs. The user device 202 may obtain a first user input comprising a user role and user requirements. The user role relates to the role of the user within an enterprise, and may be used to determine the responsibilities and duties of the user. For instance, the user role may be used to determine the process or product, or an aspect or feature of the product or process designated to the user role for report generation. The user requirements indicate the type of report to be generated, parameters of the product or process, specific outputs required, limitations or restrictions with regard to contents of report etc. The user requirements may be retrieved as responses to prompts provided at the user device. The responses are provided by the user as a selection of pre-defined options or as a natural language response. The natural language responses provided the user are parsed by a Natural Language Processing (NLP) parser for determining a context of the user requirement.

The first user input may be provided to the system 204. The system 204 may be a processing device, such a CPU, present locally or accessed by means of a server. The system 204 processes the first user input to identify one or more data sources, relevant for report generation, from a plurality of data sources 206 connected to the system 204. The one or more data sources contain information related to the process or product, hereafter referred to as product/process information. The product/process information may include raw data or processed data relating to the product or process, and such raw and processed data may be stored in different formats. The product/process information may also include reports previously generated for the product or process. The system 204 retrieves the product/process information from the one or more data sources and converts the information into a single format for ease of processing and analysis.

On retrieving the information, the system 204 identifies associations of the product/process information and the user input with previously performed statistical computations. Associations represent different statistical computations previously performed and different report layout previously used for a user input, or for a product or process. Herein, report layout relates to the different layouts and formats of representing information in a report, and also includes tools for data representation such as graphs, tables, and charts. The associations identified by the system relates to the statistical computations and reports layouts previously used with respect to the product or process, or with respect to similar products and processes. Further, the associations identified also relates to statistical computations and report layouts previously used by the same user role, or by similar user roles.

The identified associations provide an indication of the different statistical computations and report layouts previously used, based on which statistical computations and report layouts to be used for generating the report may be determined. The system 204 provides recommendations to the user, based on the statistical computations and report layouts used in the previous reports. For example, a recommendation for a report relating to performance of a product would include statistical computations generally performed for evaluating performance of the same or similar product, the graphs and tables suitable for representing data obtained from the statistical computations, and the report layout generally used for performance reports. Hence, recommendations are generated corresponding to all the identified associations by the system 204. Each recommendation is generated corresponding to an association of the identified associations. The recommendations are provided to the user at the input device 202 templates, where each recommendation is represented by a template retrieved from a template database stored in the plurality of data sources 206.

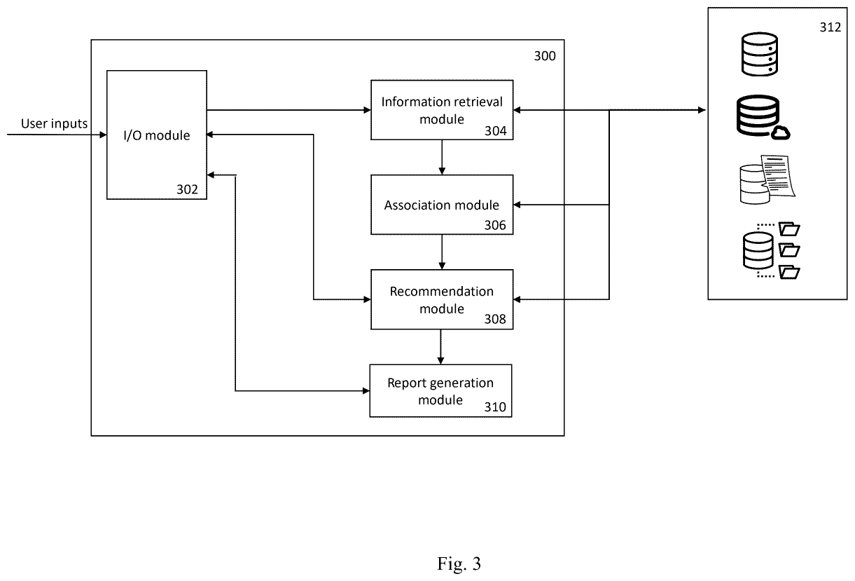

The user may select one or more of the templates provided as recommendation, and such selection is provided as a second user input. The second user input may also include modifications made to the templates selected by the user. The report is generated by incorporating statistical computations and report layouts comprised in the selected templates. The new templates created based on modifications by the user, and the report generated based on the second user input, may be saved for future reference. Further, the report generated by the system 204 is also saved for future reference. Similar to such a generation of the report for the user, the system 204 may also be used by other users U2 to Un of the enterprise for generating reports designated to them by the administrative user A. The detailed functioning of the system 204 has been provided with respect to FIG. 3.

FIG. 3 illustrate a block diagram of the proposed system 300 for generating reports, in accordance with an embodiment of the present invention. The system 300 comprises an I/O module 302, an information retrieval module 304, an association module 306, a recommendation module 308, and a report generation module 310. An interactive user interface is created by the I/O module 302 for retrieving user inputs from a user U1 of an enterprise, hereafter referred to as “the user”. A first user input retrieved from the user comprises a user role and user requirements. The user role relates to the role of the user generating the report within an enterprise. In an embodiment of the present invention, the user role may be retrieved as a response provided by the user to a request prompt for user role. In other embodiments, the user role may be determined from the user credentials provided by the user for logging into the interactive user interface. The user role may be used to determine the product or process designated to the user. In other embodiments, the aspect or feature (of a product or process) designated to the user may be determined based on the user role.

The user requirements are retrieved based on responses of the user to prompts. In an embodiment, the prompts may be provided at the interactive user interface by the I/O module 302 after the user logs in. In some embodiments of the present invention, the prompts may be generated by the I/O module 302 based on the user role. In such embodiments, customized prompts may be generated based on the types of reports the user role is designated to generate. The responses to the prompts may be retrieved as a selection of one or more options made by the user from a pre-defined set of options or as natural language responses. The pre-defined set of options may include a variety of different parameters associated with reports. For instance, the pre-defined set of options may include options relating to stage of the process or product (i.e. pre-production stage, production stage, post-production stage), options relating to type of the report such as quality report, report relating to results of testing activities, performance report, or report relating to composition of a product.

The natural language responses provided by the users to the prompts may include a detailed description of the report to be generated, or the features to be included in the report. Such natural language responses are hence descriptive of the contents required to be generated for the report, and a context regarding the user requirements may be derived based on parsing the natural language responses. The parsing may be performed by an NLP parser, and the result of such parsing may be a set of keywords associated with the user requirements.

The user role and the user requirement determined from the first user input by the I/O module 302 is thereafter provided as input to the information retrieval module 304. The information retrieval module 304 uses the user role and the user requirement for identifying one or more data sources storing information relevant for report generation. The one or more data sources are identified from a data repository 312 storing a plurality of data sources. The plurality of data sources includes local storage units or cloud storages containing information relating to different products and processes, different user roles, and reports previously generated.

The one or more data sources are identified from the plurality of data sources if the one or more data sources relate to or is associated with the product or process. For instance, if a data source contains quality testing data of a product or process, the data source is identified by the information retrieval module 304. The information retrieval module thereafter accesses the one or more data sources, and retrieves the information stored therein. The information includes raw data relating to the process or product, processed data obtained based on statistical computations previously performed on the raw data, information relating to similar products or processes, and reports previously generated for the same or similar product or process. The information retrieval module 304 creates a local copy of a product/process information, wherein the product/process information is constituted by compiling information retrieved from the one or more data sources. The information retrieved from different data sources may be of different types and formats, and hence such information are converted to a single format before compilation to obtain the product/process information.

The creation of a local copy the product/process information in a single format enables the maximal utilization of the product/process information for generating the report. The contents of the report are generated based on statistical computations performed on the product/process information. The different statistical computations performed for report generation may include different types of analysis such as trend analysis or capability analysis, different types of calculations such as yield calculation and failure rate calculation, and different mathematical calculations such as mean and standard deviation. The statistical computations to be performed on the product/process information is determined by the association module 306.

Associations represent the different statistical computations previously performed for generating reports of a product or process, and the different report layouts previously used in reports of a product or process. Hence, the statistical computations to be performed and report layouts to be used may be determined by identifying associations of the product/process information and the first user input with previously performed statistical computations and previously used report layouts. The association module 306 is used for determining such associations.

Firstly, the association module 306 identifies associations of the product/process information with previously performed statistical computations. Statistical computations performed for report generation relate to computations performed on data relating to a product or process to generate insightful data or information. The statistical computations may include complex computations such as trend analysis, capability analysis, success rate analysis, and batch failure rate analysis that provide insight regarding the quality or performance of a product or process. The statistical computations may also include simpler computations such as max, min, standard deviation, average etc. The associations identified by the association module 306 represents the statistical computations that were performed previously for the same product or process. The associations identified may also include statistical computations that were performed previously for similar products or processes. For example, if the product is a pharmaceutical drug, the associations identified would include the statistical computations previously performed with respect to the pharmaceutical drug, and the statistical computations previously performed with respect to variants of the pharmaceutical drug.

Secondly, the association module 306 identifies associations of the first user input with previously performed statistical computations. The associations identified represent the statistical computations previously performed by the user role or corresponding to the user requirements. The associations identified may also include the statistical computations previously performed by similar user roles or corresponding to similar user requirements. With reference to the previous example, if the user role is that of quality tester of the pharmaceutical drug, the associations identified would include statistical computations previously performed by a quality tester. Such computations would include one or more of batch failure rate, product recall rate, stability analysis etc.

The association module 306 may also be used for identifying association of the product/process information and the first user input with report layouts used in previous reports. The report layouts relate to the different layout and format of representing data that are used in reports. The associations identified in such an embodiment would also include report layouts that were previously used in report relating the same or similar product/process and report layouts previously used by the user role. The report layouts identified may also include the different tools for data representations such as graphs, charts, and tables. Details of the associations identified by the association module 306 may be stored in the data repository 312 for future reference. In certain embodiments, associations identified may also include tools for data representation commonly used with statistical computations identified by the association module 306.

In certain embodiments of the present invention, a Machine Learning (ML) model may be used for the identification of the associations. The ML model may be pre-trained on data relating to the product or process, statistical computations previously performed, and previous reports. The ML model may be continuously fine-tuned based on the associations identified in real-time by the association module 306. For example, an ML model for identifying associations for generating reports for a pharmaceutical company may be pre-trained on previous reports generated relating to the different pharmaceutical products of the company. The ML model may be pre-trained on training documents specifying different types of statistical computations that are generally performed for each stage of different pharmaceutical products, and statistical computations generally performed by each user role. The pre-trained ML model is thereafter used for identifying associations in real-time for different pharmaceutical products, and becomes increasingly effective and well-trained due to continuous fine-tuning based on identified associations.

The associations identified by the association module 306 are used by the recommendation module 308 to generate recommendations for the user. Each recommendation may be a statistical computation or report layout selected from the identified associations. Each recommendation is provided as an editable template, wherein the template corresponds to a statistical computation or a report layout. The template may be stored in a template database in the data repository 312, and the template corresponding to the statistical computation or the report layout of the recommendation is retrieved by the recommendation module 308 for generating the recommendation. The recommendations generated by the recommendation module are provided to the user using the I/O module 302. In certain embodiments of the present invention, a filtering of the recommendations may be performed before providing the recommendations to the user. For instance, the filtering may be performed based on a user requirement provided in the first user input, predefined parameters, or based on statistical computations that are most commonly performed for the product or process.

The selections made by the user from the recommendations provided are retrieved by the I/O module 302 as a second user input. The second user input may be one or more recommendations selected by the user at the interactive user interface. The second user input may also include modifications made to templates corresponding to the one or more recommendation. The modification made to the template of a selected recommendation may include changes in the data fields or variables of the statistical computation represented by the template, or modifications to the report layout represented by the template.

The second user input is used by the report generation module 310 to generate the report, and the report is generated based on the templates selected by the user. The modifications made to the templates by the user is saved to the template database of the data repository 312 for future reference. The record generated by the report generation module 310 is provided to the user by the I/O module 302. Further, the report generated and the statistical computations performed with respect to the user input for report generation is saved in in the data repository for future reference. The system 300 may also be used by other users U2 to Un of the enterprise for generating reports assigned to them.

The report generated by the system 300 may correspond to the quality report of a commercial product or process, or a report or chapter of the quality report of the commercial product or process. In one implementation, a plurality of reports corresponding to different chapters of a quality report for a commercial product or process may be generated by the proposed system, and the quality report may be generated by a compilation of the reports. In such implementation, a report database may be maintained at the data repository 312 for storing the reports generated, and such the report database may be accessed by the association identification module for identifying associations relevant to a report to be generated. Such an embodiment may be implemented for commercial products or processes which have multiple variants with minor changes, where each chapter or report of the quality report relates to a single variant. In such instances, the statistical computations to be performed for the different reports are substantially, and recommendations generated based on identified associations would make report generation significantly faster and easier.

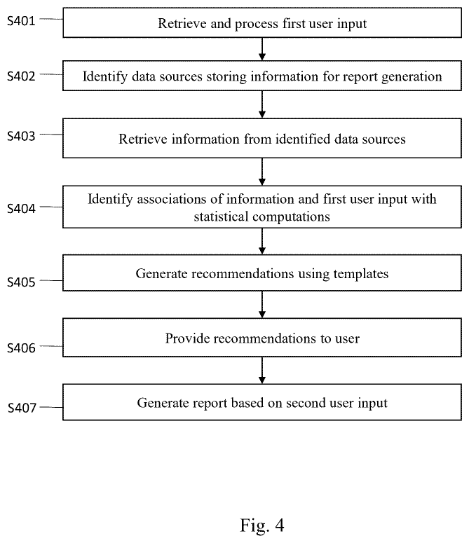

FIG. 4 illustrates steps executed by a system for generating reports, in accordance with an embodiment of the present invention. Step S401 involves retrieval of a first user input from a user U1 of an enterprise, hereafter referred to as “the user”. The first user input is retrieved from a user device by an I/O module, where the first user input comprises a user role and user requirements. The user role may be directly retrieved from the user as a response to a query or prompt, or may be determined based on user credential provided at a user interface created by the I/O module. The user requirements may be retrieved as responses to prompts generated by the I/O module. The prompts generated by the I/O module may be customized based on the user role. The responses to the prompts may be retrieved as a selection of one or more options from a pre-defined set of options, or as natural language responses. The selection of one or more options may be made corresponding to user requirements such as a product or process for which report is to be generated, stage or phase of development of the product or process, specific computations to be performed, limitations or restrictions with respect to content to be generated etc. The natural language responses provided by the user may be a detailed description of the requirement of the user, and may be parsed using an NLP parser to determine a context of the user requirements. The user role and the user requirements of the first user input are thereafter used for determining a product or process, or an aspect of the product or process, for which report is to be generated.

Step S402 involves identifying the data sources storing information relevant for report generation. The data sources are identified from a plurality of data sources stored in different locations within a data repository. The data sources are identified based on whether data sources are related to or associated with the product or process. The data sources related to or associated with similar products or processes may also be identified. The data sources identified may include databases containing data relating to the development of the product or process, databases storing data relating to testing and quality analysis activities performed for the product or process, databases containing information of similar products or processes, and databases containing reports previously generated for the same or a similar product or process. The information stored in the identified data sources are retrieved and compiled as product/process information. Prior to such compilation, the information from all the identified data sources are converted into a single format to enable ease of performing computations. A local copy of the product/process information is created for performing statistical computations.

S404 involves the identification of association of the product/process information and first user input with statistical computations performed previously. The identification of associations is performed for determining the statistical computations to be performed based on previous instance of such computations being performed for the product or process, or by the user role. The identification performed includes identifying association of product/process information with previously performed statistical computations, to determine the statistical computations previously performed for the product or process, or for similar products and processes. Such identification may be performed by accessing databases and logs maintained in the data repository relating to prior computations performed for the product or process, or used for generating reports for the product or process. The identification performed further includes identifying association of the user role with previously performed statistical computations, to determine the statistical computations previously performed corresponding to the same or similar user role, or based on the same or similar user requirements. Such an identification is performed based on reference to databases and logs maintained with respect to statistical computations performed by the user role, and statistical computations incorporated in reports generated by the user role. Additionally, the identifications performed also includes identification of associations of the product/process information and the user role with report layouts previously used. That is, reports layouts, including graphs, charts, and tables, previously used with respect to the product or process, or similar product or process is are identified. Further, reports layouts previously used by the user role or by similar user roles are identified. Step S404 also involves saving details of the associations identified in the data repository for future reference. In certain embodiments, groups of associations may be made based on similarity of statistical computations corresponding to the associations, and ranking of each association within a group may be performed. Such a ranking is performed to identified most relevant associations with respect to the product or process and the user input.

Step S405 involves generating recommendations for the user based on the associations identified at step S404. Each recommendation is generated corresponding to an identified association, i.e., to statistical computation or report layout previously associated with the product/process or the user input. An editable template corresponding to a statistical computation or a report layout provided as a recommendation is retrieved from a template database within the data repository. Multiple recommendations are generated in such a manner, where each recommendation is comprised of a template corresponding to a statistical computation or a report layout. In certain embodiments, filtering of recommendations is performed for providing the most relevant recommendations from the multiple recommendations generated.

Step 406 involves providing the recommendations to the user using the I/O module. The one or more recommendations selected by the user is retrieved as a second user input. The second user input may also include modification made by the user to the templates of the one or more selected recommendations. The second user input retrieved at step S406 is used to generate the report at step S407. The report is generated based on the templates and modifications to the templates obtained from the second user input. The report generated is provided to the user, and the templates and report generated may be stored in the data repository for future reference.

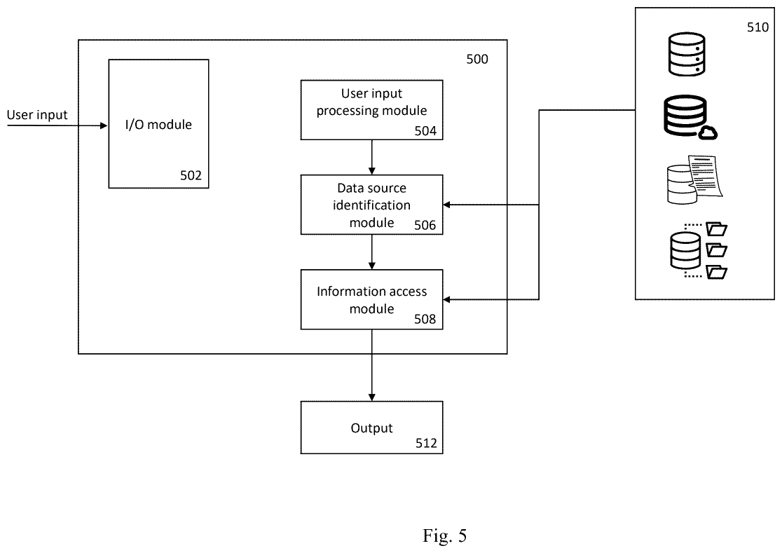

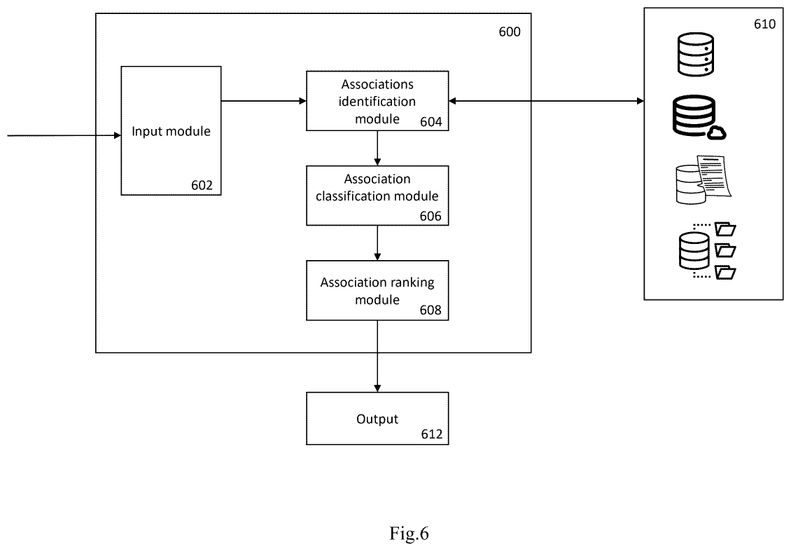

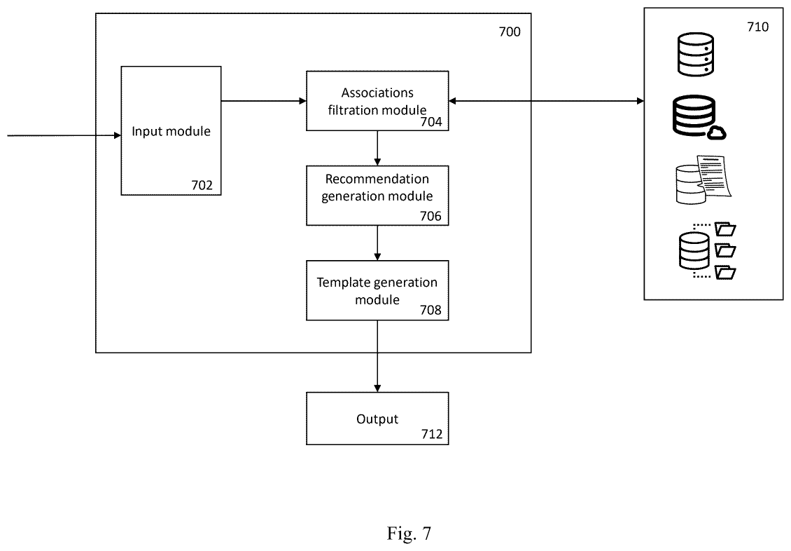

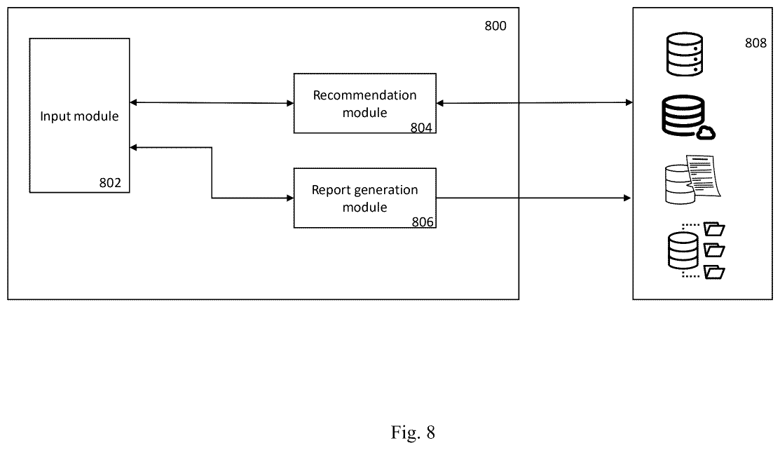

In certain embodiments of the present invention, the proposed system may be implemented as a compilation of multiple systems, each system performing specific operations relating to report generation. The multiple systems include a system for retrieving information, a system for identifying associations, a system for generating recommendation, and a system for generating a report based on recommendations selected by a user. Detailed explanation of the systems for retrieving information, identifying associations, generating recommendations, and for generating a report based on recommendations selected are provided with reference to FIG. 5, FIG. 6, FIG. 7, and FIG. 8 respectively.

FIG. 5 illustrates a system for retrieving information for report generation, in accordance with an embodiment of the present invention. The system 500 comprises an I/O module 502, a user input processing module 504, a data source identification module 506, and an information access module 508. The I/O module 502 is used to retrieve a user input from a user U1 of an enterprise, hereafter referred to as “the user”. The first user input comprises a user role and a user requirement. The user input processing module 504 processes the user input retrieved by the I/O module 502 to determine the user role and the user requirement. The user role may be determined based on the login credential provided by the user at a user interface created by the I/O module 502. The credentials may be used to data relating to the user, wherein the data includes the role of the user in an enterprise associated with the product or process, or the role of the user in the report generation process. In certain embodiments, the data may be stored in a user database in a data repository 510 comprising multiple data sources. The data may also include context regarding the duties of the user role with respect to report generation, or the data relating to the one or more reports that a user role is configured or designated to generate. In certain embodiments, the user database may also include reports previously generated by the user or user role.

The user input processing module 504 also processes the user input to determine the user requirements. The user requirements are provided by the user as responses to prompts generated at the user interface by the I/O module 502. The responses may be selections made by the user from a list of pre-defined options, wherein the options relate to different parameters associated with the report. For instance, in one implementation, the pre-defined options may relate to the aspect of the product or process, date of manufacturing of the product, testing activities to be considered etc. The responses may also be natural language responses provided by the user to the prompts, and such natural language responses are parsed by an NLP parser for determining the context of the user requirements. For instance, the natural language responses provided by the user may include a detailed description of the report to be generated. The detailed description may be parsed to obtain context of user requirements such as the product or process for which the report is to be generated, the type of report to be generated etc.

The user roles and the user requirements determined by the user input processing module 504 is provided as input to the data source identification module 506. The data source identification module 506 determines the product or process for which user report is to be generated, based on the user role and the user requirement. Thereafter, one or more data sources containing information relevant to the product or process may be identified from a plurality of data sources stored at the data repository 510. The one or more data sources are identified from the plurality of data sources if the one or more data sources are related to or associated with the product or process. For instance, if a report is to be generated for a pharmaceutical drug, all data sources related to or associated with the pharmaceutical drug are identified by the data source identification module 506. In certain embodiment, data sources previously accessed for generating reports of the same product or process, or similar products or processes may also be referred to for identifying the one or more data sources. In such embodiments, a log of the data sources accessed for each report generation may be saved at the data repository 510.

The information stored in the data sources identified by the data source identification module 506 is accessed and retrieved by the information access module 508. The information access module 508 accesses the data repository 510 and retrieves the information from each of the identified data sources. The information includes raw data relating to the process or product, processed data obtained based on statistical computations previously performed on the raw data, information relating to similar products or processes, and reports previously generated for the same or similar product or process. In certain embodiments, the information may also include statistical computations performed for the product or process, and the graphs, charts, tables, and other forms of data representation generally used for the statistical computations.

The information retrieved from the identified data sources may be of different types and formats, and may be converted to a single format and compiled as product/process information. The information access module 508 also creates a local copy of the product/process information. The local copy of the information is provided as output 512 of the system 500. In some embodiments, the output of the information retrieval module 504 may be the location or address of the local copy of the information, which may be used by other systems for generating the record. The system 500 may also be used for retrieving product/process information corresponding to first user inputs provided by other users U2 to Un of the enterprise.

FIG. 6 illustrates a system for identifying associations of a user input and a product or process with previously performed statistical computations for report generation, in accordance with an embodiment of the present invention. The system comprises an input module 602, an association identification module 604, an association classification module 606, and an association ranking module 608. The input module 602 is used to retrieve a user input and a process/product information. The user input may be retrieved from a user U1 of an enterprise, hereafter referred to as “the user”. The user input is retrieved by the input module 602, and the user input comprises a user role and user requirements. A local copy of product/process information generated corresponding to the user input is also retrieved as input by the input module 602. In some embodiments, the product/process information is provided to the input module 602 by a system for retrieving information. In other embodiments, the input provided at the input module 602 may also comprise a location of the product/process information stored in a data repository 610. The process/product information is retrieved from the data repository by the input module 602.

The product/process information and the user input obtained by the input module 602 is used by the association identification module 604 for identifying associations of the product/process information and the user input with previously performed statistical computations. Associations represent different statistical computations previously performed and different report layouts previously used for a user input, or for a product or process. Statistical computations relate to the different computations performed on data relating to a product or process. The statistical computations include complex computations such as such as trend analysis, capability analysis, success rate analysis, and batch failure rate analysis that provide insight regarding the quality or performance of a product or process. The statistical computations may also include simpler computations such as max, min, standard deviation, average etc.

The statistical computations performed for a report generally depends on the product or process for which report is to be generated. For example, statistical computations that may be performed for a pharmaceutical product depends on regulations and standards applicable to the pharmaceutical industry. Statistical computations performed for the pharmaceutical product may include potency trend which indicates potency levels of the product over different batches or time periods, dissolution profile trend which represents dissolution profiles of the product at different time points or under different conditions, impurity trend which indicate levels of impurities detected in the product over time or across different batches, content uniformity trend which represents content uniformity results of the product for multiple dosage units or batches, and stability analysis which indicates stability of the product over time. The statistical computations that may be performed for the pharmaceutical product may also include related substance calculation that quantifying the levels of related substances or degradation products in the product, yield calculation for assessing the efficiency of the manufacturing process, and batch failure rate indicating percentage of batches that failed quality tests.

Report layout relates to the layout and format of representing data used in reports. Further, report layout may also include the tools for representing data such as graphs, charts, and tables. For instance, report layouts used in for a pharmaceutical product include X-bar and R charts, X-bar and S charts, or individual/moving range (I/MR) charts to track and control variables such as assay results, impurity levels, or particle size distribution. The report layouts used for the pharmaceutical product may also include P-charts or C-charts to monitor the occurrence of categorical quality attributes, such as the presence of particulate matter or the occurrence of defects.

The association identification module 604 is used for identifying the associations, i.e., previously performed statistical computations and previously used report layouts, relevant to the product or process and the user input. The association identification module 604 firstly identifies associations of the product/process information with previously performed statistical computation. The associations identified include the statistical computations previously performed for the product or process, or for a similar product or process. Such statistical computations may be identified from reports previously generated for the same or similar product or process, and based on a log of statistical computations performed for the same or similar product or process. The log of statistical computations previously performed may be maintained as a database within the data repository 610. The associations identified also includes report layouts used previously in reports corresponding to the same or similar product or process. The report layouts may be identified from previous reports for the same or similar product or process.

The association identification module 604 thereafter identifies associations of the user input with previously performed statistical computations. The associations identified include the statistical computations previously performed by the same or similar user role, or corresponding to the same or similar user requirements. The statistical computations may be identified from reports previously generated by the same or similar user roles, or corresponding to the same or similar user requirements. The previous reports may be accessed from a report database maintained in the data repository 610. The associations identified also includes report layouts used previously in reports generated corresponding to the same or similar user input. The report layouts may be identified from previous reports for the same or similar product or process.

Further, the associations identified by the association identification module 604 may also include the report layouts associated with statistical computations identified by the association identification module 604, i.e., the data representation tools previously used for representing the output of the statistical computations. For example, if an association identified with respect to a product is that trend analysis was previously performed for the product, associations of trend analysis with different tools of representing data is performed by the association identification module 604. An association identified may be that line graphs have been previously used for representing results of trend analysis. Another association identified may be that bar charts have been previously used for representing results of trend analysis.

Details relating to the associations identified by the association identification module 604 may be saved in an associations database within the data repository 610. In certain embodiments of the present invention, a Machine Learning (ML) model may be used for the identification of the associations. The ML model may be pre-trained on data relating to the product or process, statistical computations previously performed, and previous reports. The ML model may be continuously fine-tuned based on the associations identified in real-time by the association identification module 604. As more associations are identified, the ML model can become increasingly better trained and effective in identifying associations of a product or process, or a user role, with statistical computations and report layouts. For example, the identification of associations by the ML model may be based on identifying sentences in previous reports referencing or mentioning the product/process, identifying instances of statistical computations performed by the user role, identifying statistical computations performed for the product or process etc. The machine learning algorithms for training and fine-tuning the ML model may be stored in a memory or a storage device. In certain embodiments, the associations may be identified by an ML model such as deep learning model on an independent hardware. In certain embodiments, the ML model may be pre-trained using a training set of documents and/or feature sets relating to a product or process.

The associations identified by the association identification module 604 may be used to generate groups of associations. The grouping of the associations is performed using the association grouping module 606. A plurality of association groups may be created based on the identified associations, wherein each association group comprises one or more associations corresponding to a same type of complex statistical computation. The different complex computations may include trend analysis, capability analysis, batch failure rate, quality analysis, performance analysis etc. Such complex computations may be determined in different ways, and hence there may exist a plurality of associations identified for each complex computation. Hence, the plurality of associations is grouped as an association group. For example, the associations identified may include multiple associations relating to success rate analysis. Each of the associations relating to the success rate analysis constitutes a different statistical computation previously performed for success rate analysis. In such instance, the multiple associations corresponding different statistical computations performed for success rate analysis may be grouped together.

The association groups determined using the association grouping module 606 is taken as input by the association ranking module 608. The association ranking module 608 ranks the associations within each association group based on the frequency of use in previous reports generated for the product. Such a ranking is performed to retrieve the statistical computation most commonly used by the user role or for the product or process for a complex computation. The ranking performed by the association ranking module 608 involves determining the frequency of each association in an association group with respect to the same product or process, and assigning a score based on the number of occurrences. The frequency of association is determined by analysis of records or logs saved in the data repository corresponding to previous reports generated for the same product or process. Further, the association ranking module 608 also determines the frequency of each association in the association group with respect to similar products or process, and assigns a different score based on the number of occurrences.

Similarly, the association ranking module 608 determines the frequency of each association in the association group with respect to the user role, and assigns a score based on the number of occurrences. The frequency of association is determined by analysis of records or logs saved in the data repository corresponding to previous reports generated by the user role. The association ranking module 608 determines the frequency of each association in the association group with respect to similar user roles, and assigns a different score based on the number of occurrences. After assigning such scores to each of the associations in the association group, an aggregation of the scores are performed. The associations are ranked within the association group based on the corresponding aggregated score.

The associations identified by the associations identification module 604 and the association groups with rankings determined by the association ranking module 608 is saved as the output 612 of the system 600. The output 612 may be provided to a system for generating recommendations, or may be saved in the data repository 610 for future access. The system 600 may also be used to find associations corresponding to user inputs provided by other users U2 to Un of the enterprise.

FIG. 7 illustrates a system for providing recommendations for report generation, in accordance with an embodiment of the present invention. The system 700 comprises an input module 702, an associations filtration module 704, a recommendation generation module 706, and a template generation module 708. The input module 702 is used to retrieve a user input from a user U1 of an enterprise, hereafter referred to as “the user”. The input module 702 also retrieves the associations identified and the association groups generated based on the user input. The associations and the association groups may be retrieved directly from a system for identifying associations, or may be retrieved from a data repository connected to the system 700.

The associations retrieved using the input module 702 is filtered by the association filtration module 704. The associations may be filtered when multiple associations are identified, and the most relevant associations are to be provided. The filtering performed by the association filtration module 704 for obtaining the most relevant associations include identifying essential parameters for filtering. The essential parameters may include the stage of the process or product within the development of the product or the implementation of the process. Such a parameter may be used to identify associations relevant to the stage of the process or product, i.e., statistical computations or complex computations performed at such stages. For instance, if the report is to be generated a product in post-production stage, associations relevant to the report may include performance analysis, product recall statistics etc.

The essential parameters may also be determined from the user requirement shared by the user in the user input. In certain embodiments, essential parameters for filtration may also be pre-determined for a product or a process. Based on the correlation of associations with the essential parameters, filtration of associations is performed by the associations filtration module 704.

The associations obtained after filtration is used by the recommendation generation module 706 for generating report recommendations. Each recommendation may correspond to an association, i.e., a statistical computation or report layout previously used for the product or process, or by the user role. For complex computations corresponding to which association groups are created, recommendations are first generated for associations with highest ranking. In an embodiment, a threshold may be defined with respect to rank, so as to ensure that recommendations are only generated for associations having rank above the threshold. Further, in certain embodiments, recommendations corresponding to report layout may be generated based on data representation tools required for representing output of statistical computations corresponding to which recommendations are generated. For example, if product recall rate is recommendation generated, line graphs or tables previously used for representing product recall rate are also generated as recommendations. Hence, a set of recommendations are generated by the recommendation generation module 706.

The template generation module 708 is used to generate templates corresponding to the recommendations generated by the recommendation generation module 706. The template generation module 708 retrieves a template corresponding to each recommendation from a template database maintained at the data repository 710. The template database is used to save templates for the different computations performed for products and processes. The template database also includes templates generated for previous reports based on modifications made to existing templates. The template generation module 708 retrieves a template most frequently used for a statistical computation or report layout provided in a recommendation. Hence a set of templates corresponding to the recommendations are generated by the template generation module 708. The recommendations, each comprised by a template, is directly provided to a system for generating reports. The recommendations may also be saved in a recommendations database of the data repository 710 for future reference. In certain embodiments, the templates are created as JSON templates, and are saved such that the JSON templates are easily modified by the user. The system 700 may also be used for generating recommendations for other users U2 to Un of the enterprise.

FIG. 8 illustrates a system for generating reports based on selection of recommendations, in accordance with an embodiment of the present invention. The system 800 comprises an I/O module 802, a recommendation module 804, and a report generation module 806. The I/O module 802 is used to retrieve a first user input from user U1 of an enterprise. The first user input comprises a user role and user requirements. Recommendations generated by a system for generating recommendations are retrieved as by the recommendation module 802 from a recommendations database of a data repository 808. The recommendations retrieved by the recommendation module 804 are provided to the user using the I/O module, wherein each recommendation is provided as an editable template.

A second user input is retrieved by the I/O module 802, wherein the second user input comprises a selection of one or more templates provided as recommendations. The second user input may also comprise modifications made to one or more of the selected templates. Modifications made to templates may include changes in the variables of a statistical computation provided by a template, changes in the values of data fields used in a statistical computation provided by a template, changes made to a graph, table or chart of a report layout provided as a template etc. The selected templates, and the modifications made by the user to one or more of the selected templates are taken as input by the report generation module 806 for generating a report. The report is generated based on the statistical computations and the report layouts corresponding to the selected templates. The report generated by the report generation module 806 is saved in a reports database of the data repository 808. The templates created based on modifications made to templates by the user is also saved in a templates database of the data repository 808. The system 800 may also be used to generate reports based on second user inputs provided by other users U2 to Un of the enterprise.

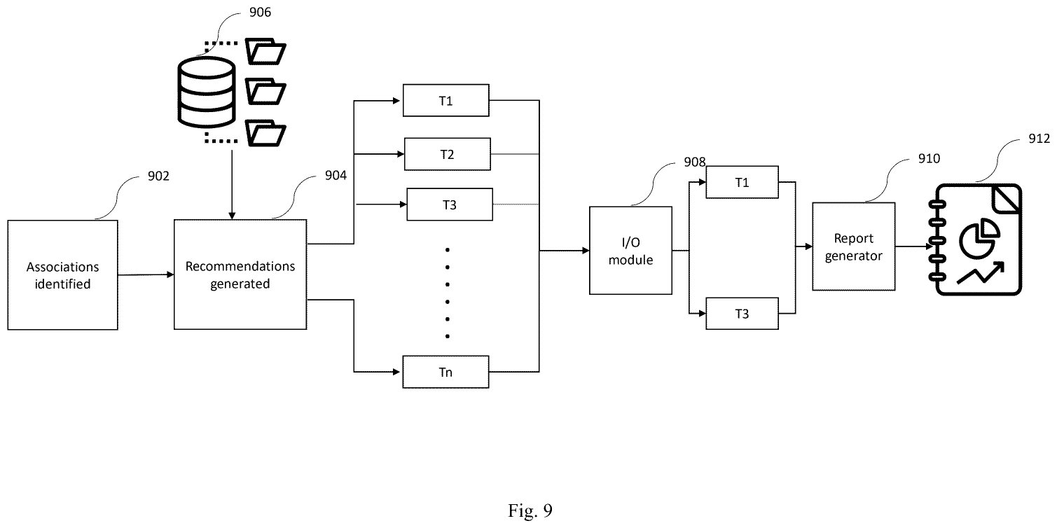

FIG. 9 illustrates a flow chart of a method of report generation, in accordance with an embodiment of the present invention. At 901, a product/process information comprising information retrieved from data sources related to or associated with a product or process is generated based on a first user input retrieved from a user U1 of an enterprise, hereafter referred to as “the user”. The first user input comprising a user role and user requirements. The product or process relating to which product/process information is generated is determined from the first user input. Based on the first user input and the product/process information, associations relevant to a report to be generated are identified at 902. Association represent statistical computations and report layouts previously used for a product or process, or by a user role. Hence the associations identified at 902 relate to statistical computations previously performed or report layouts previously used for the product or process, or by the user role. The identified associations also relate to statistical computations previously performed or report layouts previously used for similar product or process, or by similar user roles.

At 904, recommendations are generated based on the identified associations. Each recommendation generated at 904 relates to either a statistical computation or a report layout from the associations that may be used in the report. Different recommendations are generated corresponding to the multiple identified associations. A filtering of the recommendations may also be performed at 904, wherein the recommendations most relevant to the report are selected. The most relevant recommendations may be identified based on the frequency of use of the statistical computation or the report layout corresponding to the recommendations.

After recommendations are selected, templates are generated corresponding to the selected recommendations at 904. A recommendation is represented by a template, wherein the template is retrieved from a template repository 906. The template retrieved may be the most commonly used template for a statistical computation or a report layout corresponding to the recommendation. Similarly, appropriate templates are retrieved from the template repository for all the recommendations.

After the templates corresponding to the recommendations are determined, the templates T1 to Tn are provided to the user via the I/O module 908. One or more of the templates provided as recommendations may be selected by the user. In addition to the selection of the templates, the user may also make modifications to one or more of the selected templates. The selected templates (T1 and T3) along with the modifications made are received as a second user input. The selected templates are provided to a report generator unit for generating a report at 910. The report generator incorporates the statistical computations and report layouts comprised in the selected templates to generate the report 912. The report may thereafter be provided to the user, and also saved in a report database for future reference. The method illustrated by FIG. 9 may also be used by other users U2 to Un of the enterprise for generating reports assigned to them.

In an implementation of present invention, the report is generated with respect to an aspect or feature of a process or product. The proposed method of generating reports may be used for generating multiple reports relating to different features or aspects of the product or process, and the multiple reports may be combined to generate a final report. In different enterprises, the proposed system and method may be used to generate a final report corresponding to a quality report of the product or process.

In certain embodiments of the present invention, the proposed system and method may be used for generating recommendations for a partial product or process. In such an embodiment, a partial report generated corresponding to a product or process may be provided as input. Based on the input provided, a parsing tool may be used to derive context of the different statistical computations already incorporate in the partial report. Based on the statistical computations identified in the partial report, associations of statistical calculations and report layouts previously used along with or in conjunction with the identified statistical computations may be determined. Recommendations may be generated with respect to the determined associations, and such recommendations may be provided to the user as templates. For example, if a partial report comprises a failure rate analysis for a product, associations identified may include statistical computations such as product recall rate that may be commonly performed with failure rate analysis. The associations identified may also include report layouts such as line graphs for indicating change in failure rate over a period of time. Based on such recommendations provided to the user, the user may select one or more such recommendations for incorporating into the partial report.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

An interface may be used to provide input or fetch output from the system. The interface may be implemented as a Command Line Interface (CLI), Graphical User Interface (GUI). Further, Application Programming Interfaces (APIs) may also be used for remotely interacting with edge systems and cloud servers.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms company, enterprise, and manufacturing industry have been used interchangeably throughout the draft and corresponds to an entity that generates reports relating to a product or process of the entity. The reports for the product or process of the entity may be generated by the system and method proposed herein.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method of report generation, the method comprising:
receiving a first user input defining a user role and user requirement for generation of a report of a commercial process or product;
identifying one or more data sources storing information related to the commercial process or product, wherein the information includes raw data related to the commercial process or product, processed output obtained by performing statistical computations on the raw data, and reports including the processed output;
retrieving the information related to the commercial process or product from the one or more data sources;
determining associations of previously performed statistical computations with the first user input and the information related to the commercial process or product;
providing one or more recommendations based on the associations;
receiving a second user input related to one or more selections made from the one or more recommendations; and
generating the report based on the second user input.

2. The method as claimed in claim 1, further comprising using a Machine Learning (ML) model for identifying the associations and generating the report.

3. The method as claimed in claim 1, wherein the user requirement is received as a user response to system prompts, and wherein the user response is provided as a selection of predefined options or as a natural language response.

4. The method as claimed in claim 3, wherein the natural language response is parsed by a Natural Language Processing (NLP) parser for determining a context of the user requirement for enabling identification of the associations.

5. . The method as claimed in claim 1, further comprising determining association of previously used report layouts with the first user input and information related to the commercial product or process.

6. The method as claimed in claim 1, wherein each recommendation corresponds to a statistical computation or a report layout obtained from the associations.

7. The method as claimed in claim 5, wherein each recommendation is provided as an editable template selected from a set of existing templates.

8. The method as claimed in claim 6, further comprising generating new templates based on modifications made by the user to one or more of the templates.

9. The method as claimed in claim 6, wherein the statistical computations are performed on the information for inclusion of one or more of trend analysis, defect analysis, success or failure analysis, and compliance analysis in the report.

10. The method as claimed in claim 1, wherein the information for generation of the report is accessed from a plurality of data sources, and the information present in multiple formats is converted into a single format, before identification of the associations.

11. A system for report generation, the system comprising:
a processor; and
a memory coupled with the processor, wherein the memory stores program instructions configured to:
receive a first user input defining a user role and user requirement for generation of a report of a commercial process or product;
identify one or more data sources storing information related to the commercial process or product, wherein the information includes raw data related to the commercial process or product, processed output obtained by performing statistical computations on the raw data, and reports including the processed output;
retrieve the information related to the commercial process or product from the one or more data sources;
determine associations of previously performed statistical computations with the first user input and the information related to the commercial process or product;
provide recommendations for generation of the report based on the associations;
receive a second user input related to one or more selections made from the one or more recommendations; and
generate the report based on the second user input.

12. The system as claimed in claim 11, further comprising using a ML model for identifying the associations and generating the report.

13. The system as claimed in claim 11, wherein the user requirement is received as a user response to system prompts, and wherein the user response is provided as a selection of predefined options or as a natural language response, wherein the natural language is parsed by an NLP parser for determining a context of the user requirement for enabling identification of the associations.

14. The system as claimed in claim 11, further comprising determining associations of previously used report layout with the first user input and information related to the commercial product or process.

15. The system as claimed in claim 11, wherein each recommendation corresponds to a statistical computation or a report layout obtained from the associations.

16. The system as claimed in claim 15, where each recommendation is provided as an editable template selected from a set of existing templates.

17. The system as claimed as claimed in claim 15, further comprising generating new templates based on modifications made by the user to one or more of the templates.

18. The system as claimed in claim 15, wherein the statistical computations are performed on the information for inclusion of one or more of trend analysis, defect analysis, success or failure analysis, and compliance analysis in the report.

19. The system as claimed in claim 11, wherein the information for generation of the report is accessed from a plurality of data sources, and the information is converted into a single format, before identification of the associations.

20. A non-transitory computer-readable storage medium comprising computer program code for execution by one or more processors of an apparatus, the computer program code configured to, when executed by the one or more processors, cause the apparatus to:
receive a first user input defining a user role and user requirement for generation of a report of a commercial process or product;
identify one or more data sources storing information related to the commercial process or product, wherein the information includes raw data related to the commercial process or product, processed output obtained by performing statistical computations on the raw data, and reports including the processed output;
retrieve the information related to the commercial process or product from the one or more data sources;
determine associations of previously performed computations with the first user input and the information related to the commercial product or process;
provide recommendations for generation of the report based on the associations;
receive a second user input related to one or more selections made from the one or more recommendations; and
generate the report based on the second user input.
